(19) United States
(12) Patent Application Publication
(10) Pub. No.: US 2026/0067130 A1
(43) Pub. Date: Mar. 5, 2026

(54) COMMUNICATIONS NETWORK FOR A VEHICLE

(71) Applicant: Cirrus Logic International Semiconductor Ltd., Edinburgh (GB)

(72) Inventor: Michael CHANDLER-PAGE, Newbury (GB)

(73) Assignee: Cirrus Logic International Semiconductor Ltd., Edinburgh (GB)

(21) Appl. No.: 19/304,024

(22) Filed: Aug. 19, 2025

Related U.S. Application Data
(60) Provisional application No. 63/687,416, filed on Aug. 27, 2024.

(51) Int. Cl. H04L 12/46; G06F 3/16; G10K 11/178; H04J 3/06; H04L 12/40

(52) U.S. Cl. CPC H04L 12/46; G06F 3/162; G10K 11/17823; G10K 11/17873; H04J 3/0638; H04L 12/40; G10K 2210/12821; G10K 2210/3011; G10K 2210/3027; G10K 2210/501; H04L 2012/40273

(57) ABSTRACT

A communications network for a vehicle comprising: a central processing node; a zonal node; an Ethernet network coupling the central processing node to the zonal node; and an edge network coupled to the zonal node, the edge network comprising a time domain multiplexing (TDM) bus and a plurality of edge transducers coupled to the TDM bus, wherein the zonal node comprises a network bridge for bridging transducer data received from the TDM bus to the Ethernet backbone network, wherein the network bridge comprises: interface circuitry for interfacing the network bridge with the TDM bus; clock recovery circuitry for recovering a clock signal for use by the edge network from an Ethernet frame received from the Ethernet network, wherein a TDM cycle of the TDM bus is synchronised to the recovered clock signal; acoustic data receiver circuitry coupled to the interface circuitry by a first low-latency data path, wherein the acoustic data receiver circuitry is configured to transmit acoustic data contained in Ethernet frames received at the network bridge from the Ethernet network to the interface circuitry; and acoustic data transmitter circuitry coupled to the interface circuitry by a second low-latency data path, wherein the acoustic data transmitter circuitry is configured to transmit Ethernet frames containing acoustic data received at the interface circuitry from the edge network to the Ethernet network.

### FIELD OF THE INVENTION

The present disclosure relates to a communication network for a vehicle, and to a network bridge for bridging a time domain multiplexing (TDM) data network operating at a first data rate to an Ethernet network operating at a second data rate that is higher than the first data rate.

### BACKGROUND

There is a desire to provide a low-latency communications system for use in industrial applications, and particularly for automotive applications. As there is an increasing trend towards embedded electronic systems in vehicles, e.g. multi-speaker audio systems, a relatively simple, integrated, and low-latency communications system can provide for improved efficiency and ease-of-use when installing, using and maintaining such a system.

Certain audio applications in vehicles, such as Road Noise Cancellation (RNC), require very low latency between transducers (e.g. microphones, accelerometers, loudspeakers and associated amplifiers), and a central digital signal processor (DSP) running the audio application algorithms. An example of low latency in this context can be 2-12 audio sample periods at a sample rate of 48 kHz, or 41-250 μs.

Vehicle communication architectures are trending towards a zonal architecture, in which low-bandwidth, low-transceiver cost edge networks connect multiple sensors and actuators in one physical region of the vehicle to a zonal Electronic Control Unit (ECU). The zonal ECU generally comprises a network switch, connecting the zonal edge networks to a high-bandwidth backbone network. The backbone network is usually a high-speed (e.g. 1 Gbit/s or more) Ethernet network, connecting the zonal ECUs to a central high-performance compute unit, and to a vehicle cockpit system.

### SUMMARY

According to a first aspect, the invention provides a communications network for a vehicle comprising: a central processing node; a zonal node; an Ethernet network coupling the central processing node to the zonal node; and an edge network coupled to the zonal node, the edge network comprising a time domain multiplexing (TDM) bus and a plurality of edge transducers coupled to the TDM bus, wherein the zonal node comprises a network bridge for bridging transducer data received from the TDM bus to the Ethernet backbone network, wherein the network bridge comprises: interface circuitry for interfacing the network bridge with the TDM bus; clock recovery circuitry for recovering a clock signal for use by the edge network from an Ethernet frame received from the Ethernet network, wherein a TDM cycle of the TDM bus is synchronised to the recovered clock signal; acoustic data receiver circuitry coupled to the interface circuitry by a first low-latency data path, wherein the acoustic data receiver circuitry is configured to transmit acoustic data contained in Ethernet frames received at the network bridge from the Ethernet network to the interface circuitry; and acoustic data transmitter circuitry coupled to the interface circuitry by a second low-latency data path, wherein the acoustic data transmitter circuitry is configured to transmit Ethernet frames containing acoustic data received at the interface circuitry from the edge network to the Ethernet network.

The acoustic data transmitter circuitry may comprise receive buffers for receiving transducer data from each of the plurality of edge transducers.

The acoustic data transmitter circuitry may be configured to transfer transducer data from the receive buffers to a transmit buffer of the acoustic data transmitter circuitry in response to an event that is synchronous with a TDM bus cycle of the TDM bus.

The acoustic data transmitter circuitry may be configured to begin transmitting an Ethernet frame containing the transducer data as soon as the transducer data has been transferred to the transmit buffer.

The acoustic data receiver circuitry may comprise a receive buffer for receiving the acoustic data from the Ethernet frames received at the network bridge from the Ethernet network.

The acoustic data transmitter circuitry may be configured to transfer acoustic data from the receive buffer to a transmit buffer of the acoustic data transmitter circuitry in response to an event that is synchronous with a TDM bus cycle of the TDM bus.

The acoustic data receiver circuitry may be configured to begin transmitting the acoustic data as soon as the acoustic data has been transferred to the transmit buffer.

The audio data receiver circuitry and the data transmitter circuitry may be configured to operate with a frame interval not lower than a bus cycle interval of the TDM bus.

The TDM bus may be configured to carry Ethernet frames and acoustic data.

The TDM bus may comprise a twisted pair cable.

The edge transducers may be coupled to the TDM bus in a multi-drop or daisy-chain network configuration.

The plurality of edge transducers may comprise a microphone and an accelerometer.

The plurality of edge transducers may further comprise at least one of: an audio output transducer; a sensor; a light-emitting diode (LED); and a motor controller.

The edge network may be configured to convey transducer data and Ethernet frames.

The network bridge may comprise upsampler circuitry for upsampling accelerometer data received at the network bridge over the TDM bus to a rate equal to a sampling rate of microphone audio data samples received over the TDM bus.

The central processing node may comprise: an acoustic data interface; and a digital signal processor (DSP), wherein the acoustic data interface is configured to: receive Ethernet frames containing acoustic data from the Ethernet switch and transmit the acoustic data to the DSP; receive a road noise cancellation (RNC) signal from the DSP and transmit the RNC signal to the Ethernet switch for transmission to the zonal node over the Ethernet network, and wherein the DSP is configured to generate the RNC signal based on the acoustic data.

According to a second aspect, the invention provides a network bridge for bridging a time domain multiplexing (TDM) data network operating at a first data rate to an Ethernet network operating at a second data rate that is higher than the first data rate, the network bridge comprising: interface circuitry for interfacing the network bridge with the TDM data network; clock recovery circuitry for recovering a clock signal for use by the TDM data network from a from a frame received from the Ethernet network; acoustic data receiver circuitry coupled to the interface circuitry by a first low-latency data path, wherein the acoustic data receiver circuitry is configured to transmit acoustic data contained in Ethernet frames received at the network bridge from the Ethernet network to the interface circuitry; and acoustic data transmitter circuitry coupled to the interface circuitry by a second low-latency data path, wherein the acoustic data transmitter circuitry is configured to transmit Ethernet frames containing acoustic data received at the interface circuitry from the TDM data network to the Ethernet network.

The network bridge may further comprise upsampler circuitry configured to upsample transducer data received from the TDM data network.

According to a third aspect, the invention provides an integrated circuit comprising the network bridge of the second aspect.

According to a fourth aspect, the invention provides a road noise cancellation (RNC) system for a vehicle, the RNC system comprising: a central compute ECU; a zonal ECU coupled to the central compute ECU by an Ethernet network; and an edge network, the edge network comprising an accelerometer and a microphone coupled to a time domain multiplexing (TDM) bus, wherein the zonal ECU comprises a network bridge configured to bridge acoustic data received from the edge network to the Ethernet network, and wherein the central compute ECU is configured to: receive the acoustic data from the Ethernet network; generate a road noise cancellation signal based on the received acoustic data; and transmit the road noise cancellation signal to an audio output transducer over the Ethernet network.

According to a fifth aspect, the invention provides a communications network for a vehicle comprising: a central processing node; a zonal node; an Ethernet network coupling the central processing node to the zonal node; and an edge network coupled to the zonal node, the edge network comprising a time domain multiplexing (TDM) bus and a plurality of edge transducers coupled to the TDM bus, wherein the zonal node comprises a network bridge for bridging acoustic data received from the TDM bus to the Ethernet backbone network.

According to a sixth aspect, the invention provides a host device comprising the communications network of the fifth aspect, wherein the host device comprises a car, a commercial vehicle, a truck, a lorry, a bus, an aircraft or a room-based noise cancellation device.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the invention will now be described, strictly by way of example only, with reference to the accompanying drawings, of which:

FIG. 1 is a schematic representation of an example vehicle communication architecture that uses a first network for non-audio functionality and a second network for transmission of audio data.

FIG. 2 is a schematic representation of an example vehicle communication architecture;

FIG. 3 provides a graphical representation of minimum transmission intervals for repeated minimum length frames at different Ethernet bit rates;

FIG. 4 illustrates the use of synchronous time division multiplexing to convey audio sample data;

FIG. 5 is a schematic representation of an example communications network for a vehicle according to the present disclosure;

FIG. 6 is a schematic representation of the central high-performance compute ECU 600 of FIG. 5;

FIG. 7 is a schematic representation of a zonal ECU 700 of the communications network of FIG. 5

FIG. 8 is a schematic representation of a network bridge 800 of the communications network of FIG. 5; and

FIG. 9 is a timing diagram illustrating timing of audio sample events and transmission of audio over Ethernet frames in the communications network of FIG. 5.

### DETAILED DESCRIPTION

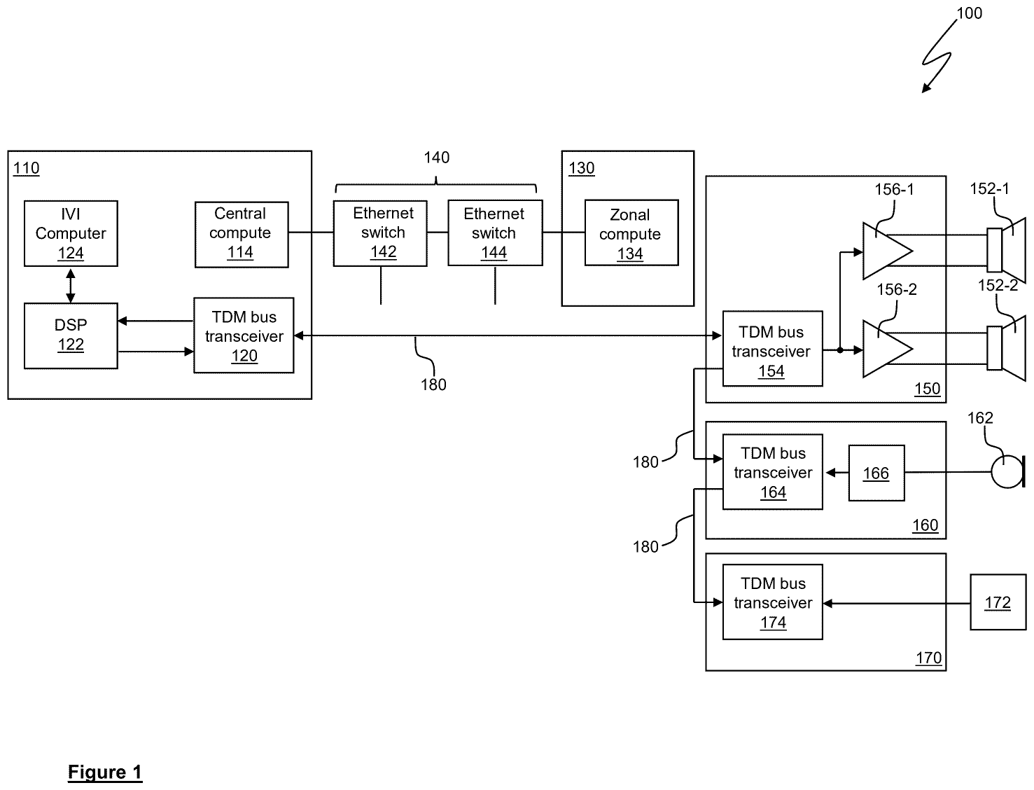

FIG. 1 is a schematic representation of an example vehicle communication architecture which uses a first network for non-audio functionality such as transmission of control data and a second network for transmission of audio data.

The vehicle communication architecture, shown generally at 100 in FIG. 1, includes a central high-performance compute ECU 110 and a zonal ECU 130 coupled together by a high-speed (e.g. 1 Gbit/s-10 Gbit/s) Ethernet backbone network 140. The vehicle communication architecture 100 further includes a first TDM interface transceiver 150 coupled to first and second audio output transducers 152-1, 152-2, which in this example are speakers, a second TDM interface transceiver 160 coupled to a first input transducer 162, which in this example is a digital microphone, and a TDM edge interface transceiver 170 coupled to a second input transducer 172, which in this example is an accelerometer.

The central high-performance compute ECU 110 includes a central compute unit 114, which is configured to be coupled to the Ethernet backbone network 140 to transmit Ethernet data to, and to receive Ethernet data from, the zonal ECU 130.

The central high-performance compute ECU 110 further includes a time division multiplexing (TDM) bus transceiver 120 which is bidirectionally coupled to a digital signal processor (DSP) 122, e.g. via an inter-IC sound (I2S) interface. The DSP 122 is bidirectionally coupled to an in-vehicle infotainment (IVI) computer 124.

The zonal ECU 130 includes a zonal compute unit 134, which is configured to be coupled to the Ethernet backbone network 140, to allow the zonal compute unit 134 to transmit Ethernet control data to, and to receive Ethernet control data from, the central high-performance compute ECU 110.

The Ethernet backbone network 140 in this example includes first and second intermediate Ethernet switches 142, 144, but it will be appreciated by those of ordinary skill in the art that the Ethernet backbone network 140 may comprise more or fewer intermediate Ethernet switches.

The first TDM interface transceiver 150 includes a first TDM bus transceiver 154 which is coupled to first and second audio amplifiers 156-1, 156-2, to supply audio output signals to the first and second audio amplifiers 156-1, 156-2. Outputs of the first and second audio amplifiers 156-1, 156-2 are coupled, respectively, to the first and second audio output transducers 152-1, 152-2.

The TDM bus transceiver 164 of the second TDM interface transceiver 160 is coupled, via a decimator 166, to the first input transducer 162, which in this example is a digital microphone. The first input transducer 162 supplies audio data (e.g. pulse density modulated (PDM) audio data) at a first data rate (e.g. 3.072 MHz) to the decimator 166, which decimates the received audio data and supplies audio data (e.g. at a conventional digital audio data rate of 48 kHz) to the TDM bus transceiver 164. The TDM bus transceiver 164 transmits the digital audio data to the TDM bus transceiver 120 of the central high-performance compute ECU 110, via a daisy-chain configured TDM bus 180 (as will be explained in more detail below), for processing by the DSP 122 of the central high-performance compute ECU 110.

A TDM bus transceiver 174 of the third TDM interface transceiver 170 is coupled to the second input transducer 172, e.g. via a synchronous serial interface. The second input transducer 172 in this example is a three-dimensional accelerometer that provides three channels of accelerometer data to the TDM bus transceiver 174. The TDM bus transceiver 174 transmits the accelerometer data to the TDM bus transceiver 120 of the central high-performance compute ECU 110, via the daisy-chain configured TDM bus 180, for processing by the DSP 122 of the central high-performance compute ECU 110.

The TDM bus transceiver 120 of the central high-performance compute ECU 110 is bidirectionally coupled to the TDM bus transceiver 154 of the first TDM interface transceiver 150 by the TDM bus 180, which may comprise, for example, a twisted pair cable. The TDM bus transceiver 154 of the first TDM interface transceiver 150 is also coupled to the respective TDM bus transceivers 164, 174 of the second and third TDM interface transceivers 160, 170 by the TDM bus 180. The TDM bus transceivers 120, 154, 164, 174 are coupled to the TDM bus 180 in a daisy-chain configuration, such that, for example, data transmitted by the TDM bus transceiver 174 of the third TDM interface transceiver 170 is first transmitted over the TDM bus 180 from the TDM bus transceiver 174 to the TDM bus transceiver 164 of the second TDM interface transceiver 160, is then transmitted over the TDM bus 180 from the TDM bus transceiver 164 to the TDM bus transceiver 154 of the first TDM interface transceiver 150, and is then transmitted over the TDM bus 180 from the TDM bus transceiver 154 to the TDM bus transceiver 120 of the central high-performance compute ECU 110. The TDM bus 180 thus enables communication of non-Ethernet acoustic (e.g. audio and/or accelerometer) data between the first, second and third TDM interface transceivers 150, 160, 170 and the central high-performance compute ECU 110.

The TDM bus 180 of the vehicle communication architecture 100 enables full-bandwidth audio playback (e.g. music, telephony, synthetic powertrain sound, user interface sounds) from the IVI computer 124 to the audio amplifiers 156-1, 156-2, and full bandwidth audio capture, e.g. for telephony and voice commands, from the first input transducer 162 to the IVI computer 124. The TDM bus 180 also enables Road Noise Cancellation (RNC), involving transmission of limited bandwidth audio data from the first input transducer 162 and acoustic vibration data from the second input transducer 172 to the DSP 122, and limited bandwidth output of an RNC audio output signal to the audio amplifiers 156-1, 156-2.

The Ethernet backbone network 140 enables transmission of non-audio data (e.g. control data) between the central high-performance compute ECU 110 and the zonal ECU 130.

Thus, the vehicle communication architecture 100 shown in FIG. 1 includes a first data network, in this example an Ethernet network, for transmission of non-audio data such as control data, and a second network, in this example a TDM network, for transmission of acoustic data such as audio and vibration data.

As will be appreciated by those of ordinary skill in the art, the provision of a second data network alongside the first data network increases the amount of cabling required to implement the vehicle communication architecture 100. As cabling is a major source of cost and weight for vehicles, it would be advantageous to eliminate the need for additional cables for an RNC system.

The present disclosure proposes a novel approach for applications implementing low-latency audio connectivity between edge nodes and a central high performance compute ECU, such as in typical future automotive network architectures, in which the edge network uses a network technology other than Ethernet (e.g. TDM), while a backbone network may convey the low-latency audio over a higher data rate network such as Gigabit Ethernet.

In particular, the present disclosure proposes a network bridge enabling low-latency connectivity between a TDM network interface transceiver (such as a low-latency, low-bit-rate TDM audio network interface transceiver intended for connection to relatively low-cost, low bit-rate peripherals such as microphones and amplifiers) and a low-latency, high-bit-rate Ethernet transceiver (such as an audio-over-Ethernet transceiver intended for connection to a central processing unit (such as a high-performance compute ECU) via an Ethernet network.

In one example application, the network bridge of the present disclosure enables low-latency audio connectivity between low-bit-rate, low-cost edge devices of an edge network and an Ethernet-connected central high-performance compute ECU in a vehicle communication architecture. The network bridge enables the low-latency acoustic (e.g. audio and/or accelerometer) data for a vehicle Road Noise Cancellation system to be conveyed over the existing cabling for the high-bit-rate “backbone” Ethernet network, from one or more distal Zonal ECUs to a central audio processing ECU, instead of requiring additional cabling in parallel with the Ethernet network to convey the low-latency acoustic data over TDM to the central high-performance compute ECU. As cabling is a major source of cost and weight for vehicles, there is considerable advantage to eliminating the need for additional cables for a Road Noise Cancellation system.

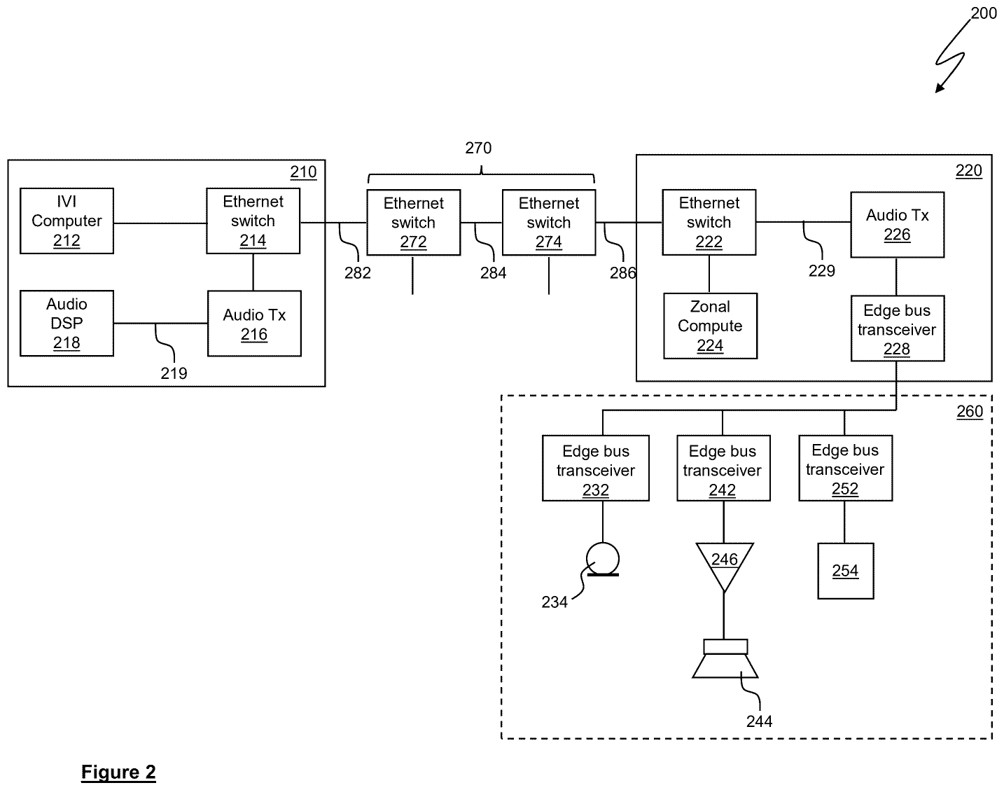

FIG. 2 is a schematic representation of an example vehicle communication architecture.

The vehicle communication architecture, shown generally at 200 in FIG. 2, comprises a central high-performance compute ECU 210, a zonal ECU 220, a plurality (in this example three) of edge bus transceivers 232, 242, 252, and a corresponding plurality (again, in this example three) of edge transducers, which in this example comprise a microphone 234, a speaker 244 and an accelerometer 254. The vehicle communication architecture 200 further includes an Ethernet backbone network 270 comprising (in this example) first and second intermediate Ethernet switches 272, 274 for coupling the central high-performance compute ECU 210 to the zonal ECU 220, by means of high-speed (e.g. 1 Gbit/s) Ethernet connections 282, 284, 286. FIG. 2 shows two intermediate Ethernet switches 272, 274, but it will be appreciated that a vehicle communication architecture could include more than two intermediate Ethernet switches in the Ethernet backbone network 270.

Each edge transducer 234, 244, 254 is coupled to a respective one of the edge bus transceivers 232, 242, 252. The speaker 244 in this example is coupled to a second one 242 of the plurality of edge bus transceivers via an audio amplifier 246. The edge bus transceivers 232, 242, 252, edge transducers 234, 234, 254 and any associated components (the audio amplifier 246 in this example) together constitute an edge network 260.

The central high-performance compute ECU 210 includes an in-vehicle infotainment (IVI) computer 212 which is coupled to an Ethernet switch 214. The central high-performance compute ECU 210 further includes a hardware audio data transmitter 216, which is also coupled to the Ethernet switch 214. An audio digital signal processor (DSP) 218 is coupled to the hardware audio data transmitter 216 to receive audio data from and transmit audio data to the hardware audio data transmitter 216. The Ethernet switch 214 permits multiple Ethernet endpoints within the central high-performance compute ECU 210 (in this example the IVI computer 212 and the hardware audio data transmitter 216) to connect to the Ethernet backbone network 270. The Ethernet switch 214 in this example allows the IVI computer 212 to receive data (e.g. control data) from and transmit data (e.g. control data) to the zonal ECU 220 over the Ethernet backbone network 270, and allows the hardware audio data transmitter 216 to receive acoustic data (e.g. audio data and accelerometer data) from and to transmit acoustic data (e.g. audio data) to the zonal ECU 220 over the Ethernet backbone network 270.

The zonal ECU 220 includes an Ethernet switch 222. A zonal compute unit 224 is coupled to the Ethernet switch 222. The zonal ECU 220 further includes a hardware audio data transmitter 226 coupled to the Ethernet switch 222 to transmit audio data to and receive audio data from the Ethernet switch 222. An edge bus transceiver 228 is coupled to the hardware audio data transmitter 216 for communication with the edge network 260. The Ethernet switch 222 permits multiple Ethernet endpoints within the zonal ECU 220 (in this example the zonal compute unit 224 and the hardware audio data transmitter 226) to connect to the Ethernet backbone network 270. The Ethernet switch 222 in this example allows the zonal compute unit 224 to receive data (e.g. control data) from and transmit data (e.g. control data) to the central high-performance compute ECU 210 over the Ethernet backbone network 270, and allows the hardware audio data transmitter 226 to receive acoustic data (e.g. audio data) from and to transmit acoustic data (e.g. audio data and vibration data) to the central high-performance compute ECU 210 over the Ethernet backbone network 270.

The hardware audio data transmitters 216, 226 may be configured to implement an audio-over-Ethernet protocol such as IEEE 1722 (also known as Audio Video Bridging) or a similar protocol, and may be configured for minimum latency at a network gross bit rate of 1 Gbit/s. The hardware audio data transmitter 216 of the central high-performance compute ECU 210 is coupled to the audio DSP 218 via a low-latency digital interface 219 such as a Direct Memory Access (DMA) interface. Similarly, the hardware audio data transmitter 226 of the zonal ECU 220 is coupled to the edge bus transceiver 228 via a low-latency digital interface 229 such as a Direct Memory Access (DMA) interface.

A total latency from a transducer of the edge network 260 to the audio DSP 218 of the central high-performance compute ECU 210 may be measured from an edge bus transducer node (e.g. a node coupled to an output of the microphone 234 or the accelerometer 254) to the audio DSP 218. In the reverse direction, a total latency from the audio DSP 218 to the speaker 244 may be measured from the audio DSP 218 to an edge bus transducer node coupled to an input of the speaker 244.

Table 1 below shows representative end-to-end audio latencies for two different cases.

Case A assumes aggressive design choices for minimising system latency. In case A, a latency of the edge bus transceivers 228, 232, 242, 252 is equal to two 48 KHz audio sample periods (approximately 41.6 μs) and the intermediate Ethernet switches 272, 274 use time-sensitive networking (TSN) cut-through switching.

Case B assumes pessimistic design choices for minimising system latency. In case B, the latency of the edge bus transceivers 228, 232, 242, 252 is equal to six 48 kHz audio sample periods (approximately 125 μs) and the intermediate Ethernet switches 272, 274 use store-and-forward switching with TSN prioritisation and credit-based traffic shaping. Worst-case latency is assumed at each Ethernet switch hop given substantial conflicting traffic.

TABLE 1

| | Latency | Latency |
|---|---|---|
| Item | (Case A) (μs) | (Case B) (μs) |
| Edge bus 228 | 41.6 | 125 |
| Audio data transmitter 226 | <1 | <1 |
| Ethernet switch 222 | 3 | 14 |
| Each intermediate Ethernet | 3 | 14 |
| switch 272, 274 | | |
| Ethernet switch 214 | 3 | 14 |
| Audio data transmitter 216 | <1 | <1 |
| Total latency with two intermediate | 53 | 169 |
| Ethernet switches 272, 274 (μs) | | |

Low latency audio transmission over Ethernet requires Ethernet frames containing audio sample data to be transmitted at short time intervals of less than the target latency, and which may be as short as one frame transmitted every audio sample period. Even transmitting a plurality of channels simultaneously, the data to be conveyed is similar to or less than the payload of a minimum length Ethernet frame (64 octets). At 1 Gbit/s, the transmission time of a minimum-length Ethernet frame, including an inter-frame gap (IFG) and preamble is just 672 ns, and using priority “cut-through” routing mechanisms in Ethernet switches with Time Sensitive Networking and Quality of Service features, the total time added to transit an Ethernet switch may be of the order of 1.5 μs.

A typical future automotive Ethernet backbone network uses a transmission rate of 1 Gbit/s and 1-3 Ethernet switch “hops” in the path between a zonal ECU 220 and a central high-performance compute ECU 210. As will be apparent from Table 1 above, audio samples may transit the Ethernet network from the zonal ECU 220 to the central high-performance compute ECU 210 in much less than one audio sample period (20.83 μs). This is possible because, at the high transmission rate of the backbone network, transmission time and hop time is roughly an order of magnitude lower than the audio sample period.

In automotive edge networks, lower bandwidth requirements and lower node costs limit transmission rates to the range 10-100 Mbit/s. At these transmission rates, the transmission time for a minimum-length Ethernet frame, including the preamble and IFG, is 67.2 μs to 6.72 μs, as will now be explained.

The minimum valid size of an Ethernet frame, excluding preamble and inter-frame gap (or IFG) is 64 octets. A typical set of header metadata in an Ethernet frame comprises 46 octets, leaving 18 octets available for audio. If the frame carries one 16-bit audio sample (2 octets), the frame must contain an additional 16 octets of padding so that the frame size is the minimum length of 64 octets, as illustrated in Table 2 below.

TABLE 2

| Field | Size (Octets) |
|---|---|
| MAC destination address | 6 |
| MAC source address | 6 |
| IEEE 1722 AAF frame header | 30 |
| Audio sample data 1 channel 16 bits | 2 |
| Padding | 16 |
| FCS | 4 |
| Total | 64 |

The frame must also include a preamble (8 octets) and an inter-frame gap (IFG), of a duration equivalent to 12 octets. This means that the minimum interval between transmitting minimum-length Ethernet frames is 84 octet periods, or 672 bit periods. At a transmission rate of 10 Mbits/s, transmission of such a minimum-length Ethernet frame takes 67.2 μs, whereas at a transmission rate of 100 Mbits/s, transmission takes 6.72 μs. For an Ethernet frame conveying one 16-bit audio sample, this is very inefficient, taking 672 bit periods to convey 16 bits of data (resulting in a protocol efficiency of 2.4%). Even if Ethernet frames are transmitted at intervals to convey 6 consecutive 48 KHz audio samples (125 μs, the minimum transmission interval for IEEE 1722 AAF), the resulting protocol efficiency is still only 14% (672 bit periods to convey 96 bits of data).

Because of this low transmission efficiency, Ethernet is not a suitable technology for low-latency audio connectivity in low-bit-rate edge networks. Instead, time division multiple access (TDM) networks (e.g. a TDM network of the kind described above with reference to FIG. 1) may provide appropriate efficiency at lower transmission rates for low-latency edge network audio connectivity, and these networks may be adapted to also carry Ethernet control data alongside low-latency audio.

For digital audio at a sample rate of 48 KHz, the interval between audio samples is 20.83 μs. To achieve transport latency of a single audio sample period, it is necessary to transmit audio frames at the sample rate.

Table 3 below shows the minimum transmission interval for repeated minimum length frames for different Ethernet bit rates.

TABLE 3

| Ethernet physical | Gross bit | Minimum transmission interval for | |
|---|---|---|---|
| layer | rate | repeated minimum length frames | |
| 10BaseT1S | 10M | 67.2 | μs |
| 100BaseT1 | 100M | 6.72 | μs |
| 1000BaseT1 | 1000M | 0.672 | μs |
| 2.5GBaseT1 | 2500M | 0.270 | μs |

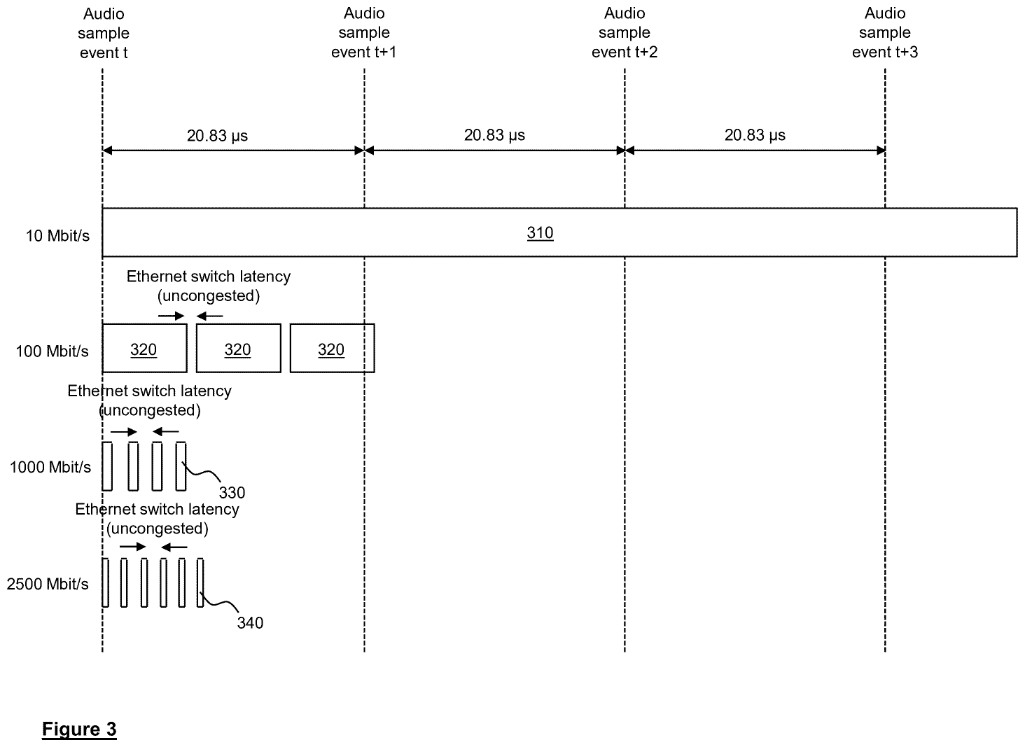

As will be apparent from Table 3 and FIG. 3, it is not possible to transmit audio frames at a rate equal to an audio sample rate of 48 kHz using 10 Mbit/s Ethernet, because the minimum frame transmission interval of 67.2 μs (i.e. the time it takes to effectively transmit one Ethernet frame containing a single 16-bit audio sample), represented by block 310 in FIG. 3, is over three times longer than the audio sample interval of 20.83 μs.

Using 100 Mbit/s Ethernet, it is possible to transmit audio frames at a rate equal to an audio sample rate of 48 kHz, although the frame transmission interval is a substantial proportion (32.3%) of the audio sample interval of 20.83 μs. Such a frame (represented by blocks 320 in FIG. 3) can only be retransmitted twice via Ethernet network switches before the latency budget of 20.83 μs is exhausted.

Using 1000 Mbit/s Ethernet, the frame transmission interval of 0.672 μs is a very small proportion (3.23%) of the audio sample interval of 20.83 μs. Such a frame (represented by blocks 330 in FIG. 3) can be retransmitted multiple times via Ethernet network switches within the latency budget of 20.83 μs.

Using 2500 Mbit/s Ethernet, the frame transmission interval of 0.270 μs is a very small proportion (1.3%) of the audio sample interval of 20.83 μs. Such a frame (represented by blocks 340 in FIG. 3) can be retransmitted multiple times via Ethernet network switches within the latency budget of 20.83 μs.

Network connections with signalling rates of 1000 Mbit/s or higher are commonly found in next-generation automotive networks to enable functionality such as radars, cameras, displays, advanced driving assistance, driver monitoring, autonomous driving, vehicle connectivity, powertrain management and chassis management. These applications require high data rates, and their value justifies the relatively high cost of network connectivity interfaces supporting such high data rates.

Automotive audio peripherals such as microphones have cost, size and power constraints that preclude the use of such high-speed network interfaces. Instead, they typically may have data interfaces at 10-100 Mbit/s. At a signalling rate of 10 Mbit/s, a signalling scheme without the overhead of Ethernet and its burdensome minimum frame length is required to convey audio sample data within a latency bound acceptable for Road Noise Cancellation applications. For example, synchronous time division multiplexing can be used to convey audio sample data within an interval of six 48 KHz sample periods (125 μs).

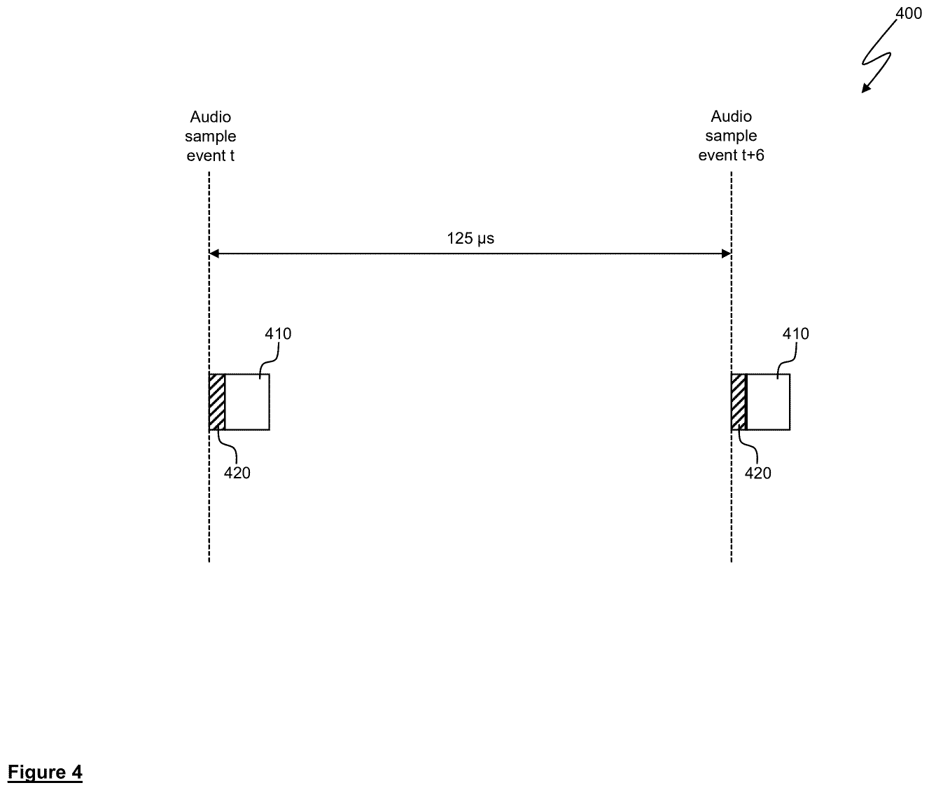

FIG. 4 illustrates the use of synchronous time division multiplexing to convey audio sample data.

In the example shown generally at 400 in FIG. 4, one audio data frame 410 containing six samples of 16-bit audio data is transmitted per 125 μs transmission interval. A TDM frame indicator 420 is transmitted by a synchronisation primary device prior to the transmission of the audio data, to signal to a receiving device that the audio data frame 410 will be transmitted.

At a signalling rate of 10 Mbit/s, the audio data frame 410 takes 9.6 μs to transmit, excluding any signalling overhead. Thus, over 110 μs (1110 bit periods, at 10 Mbit/s) remains available for any necessary signalling overhead and additional audio data frames within the transmission interval after the transmission of the audio data frame 410 before the transmission of a next TDM frame indicator 420.

At a signalling rate of 1000 Mbit/s or higher, as is typically found in next-generation backbone automotive networks, minimum-length Ethernet frames can be used to convey audio sample data in a small proportion of the audio sample interval. Although the protocol efficiency of these frames is low, they comprise a very small proportion of the total bandwidth available on the network, so as a proportion of the available bandwidth, the bandwidth wasted by the low protocol efficiency is negligible.

For example, conveying four audio channels at 16-bit 48 KHz sample rate on a 1000 Mbit/s Ethernet network at one frame per audio sample period, each minimum-length Ethernet frame conveys four 16-bit audio samples (8 octets). As discussed above, a minimum-length Ethernet frame is 64 octets in length and thus takes 84 octet-periods of network time to transmit, including 20 octet-periods for the preamble and inter-frame gap. The protocol efficiency in this example is equal to 8/84=9.5%, and the overhead is 76 octet periods per frame. As a result, on a per-frame basis, the protocol efficiency is low. However, at a signalling rate of 1000 Mbit/s, approximately 2604 octet periods are available per 48 KHz sampling period, and so the proportion of available bandwidth lost to the low efficiency of the Ethernet protocol is equal to the octet period overhead per frame divided by the number of available octet periods per audio sample period, i.e. 76/2604=3%, which is low.

As another example, conveying 4 audio channels at 16-bit 48 KHz sample rate on a 1000 Mbit/s Ethernet network, at one frame per six audio sample periods, each Ethernet frame conveys 24 16-bit audio samples (48 octets), and assuming IEEE 1722 headers, the total frame length is 94 octets, and takes 114 octet-periods of network time. Protocol efficiency=48/114=42%, overhead is 66 octet periods per frame. Per frame, the protocol efficiency is still low, although not as low as the example above in which one frame is transmitted per 48 KHz audio sample period. At 1000 Mbits/s, the number of octet periods available on the network per six audio sample period frame interval (125 μs) is 15625, so the proportion of available bandwidth lost to the low efficiency of the Ethernet protocol=66/15625=0.42%, which is extremely low.

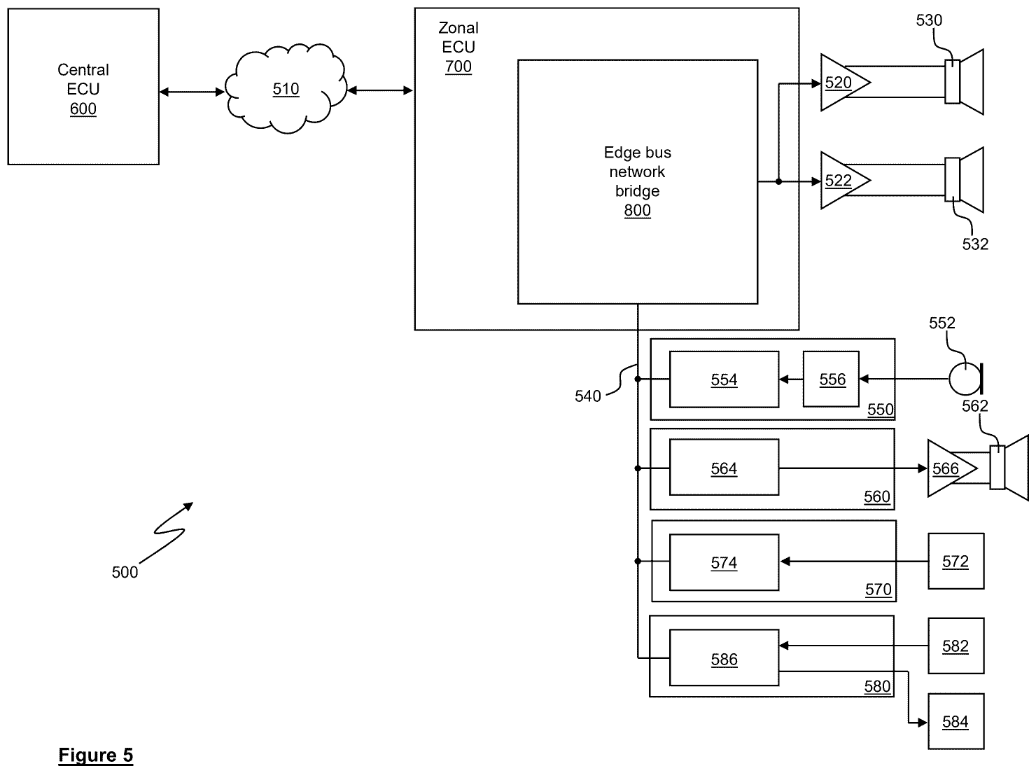

FIG. 5 is a schematic representation of an example communications network for a vehicle according to the present disclosure.

The communications network, shown generally at 500 in FIG. 5, includes a central processing node in the form of a central high-performance compute ECU 600 and a zonal node in the form of a zonal ECU 700. The central high-performance compute ECU 600 is coupled to the zonal ECU 700 by a high speed (e.g. 1 Gbits/s-10 Gbits/s) Ethernet backbone network 510. The example communications network 500 of FIG. 5 is shown as including only one zonal ECU 700, for the sake of clarity, but it will be appreciated by those of ordinary skill in the art that a practical implementation of a communications network for a vehicle will include a plurality of zonal ECUs 700.

The zonal ECU 700 includes a network bridge 800 which is coupled (e.g. via an I2S interface) to inputs of first and second audio amplifiers 520, 522. Outputs of the first and second audio amplifiers 520, 522 are coupled, respectively, to first and second audio output transducers 530, 532, which in this example are speakers.

The network bridge 800 is also coupled to a TDM edge network comprising a TDM bus 540, a plurality (in this example four) of edge bus interfaces 550, 560, 570, 580 and a plurality (in this example five) of edge transducers 552, 562, 572, 582, 584. The TDM bus 540 may comprise, for example, a twisted pair cable. The edge bus interfaces 550-580 may be coupled to the TDM bus 540 in a multi-drop or daisy-chain network configuration.

In the example shown in FIG. 5, a first edge bus interface 550 includes a TDM edge network transceiver 554 that is coupled to the first edge transducer 552, which in this example is a digital microphone, via a decimator 556. The first edge transducer 552 supplies transducer data in the form of audio data (e.g. pulse density modulated (PDM) audio data) at a first data rate (e.g. 3.072 MHz) to the decimator 556, which decimates the received audio data and supplies audio data (e.g. at a conventional digital data rate of 48 kHz) to the TDM edge network transceiver 554, which transmits the reduced-rate audio data to the network bridge 800 of the zonal ECU 700 via the TDM bus 540.

A second edge bus interface 560 includes a TDM edge network transceiver 564 that is coupled to the second edge transducer 562, which in this example is an audio output transducer (e.g. a speaker), via an audio amplifier 566. The second edge transducer 562 receives transducer data in the form of audio data (e.g. RNC audio data) from the network bridge 800 via the TDM bus 540.

A third edge bus interface 570 includes a TDM edge network transceiver 574 that is coupled to the third edge transducer 572, which in this example is a three-dimensional accelerometer that provides transducer data, which in this example comprises three channels of accelerometer data at a data rate of 48 KHz to the TDM edge network transceiver 574, which transmits the accelerometer data to the network bridge 800 of the zonal ECU 700.

A fourth edge bus interface 580 includes a TDM edge network transceiver 586 that is coupled to the fourth and fifth edge transducers 582, 584. In this example the fourth edge transducer 582 is a sensor such as an ultrasonic, motion or position sensor that is coupled to the edge network transceiver 586, e.g. via an I2C interface, to supply transducer data in the form of sensor data to the TDM edge network transceiver 586, which transmits the sensor data to the network bridge 800 of the zonal ECU 700. The fifth edge transducer 584 in this example is an output transducer or transducer controller such as one or more light-emitting diodes (LEDs), a motor controller or the like, which is coupled to the edge network transceiver 586, e.g. via an SPI interface. The edge network transceiver 586 of the fourth edge bus interface 580 is operative to transmit Ethernet data (e.g. Ethernet sensor data) received from the fourth edge transducer 582 to the network bridge 800 via the TDM bus 540, and to transmit Ethernet data (e.g. Ethernet control data) received by the edge network transceiver 586 from the network bridge 800 to the fifth edge transducer 584.

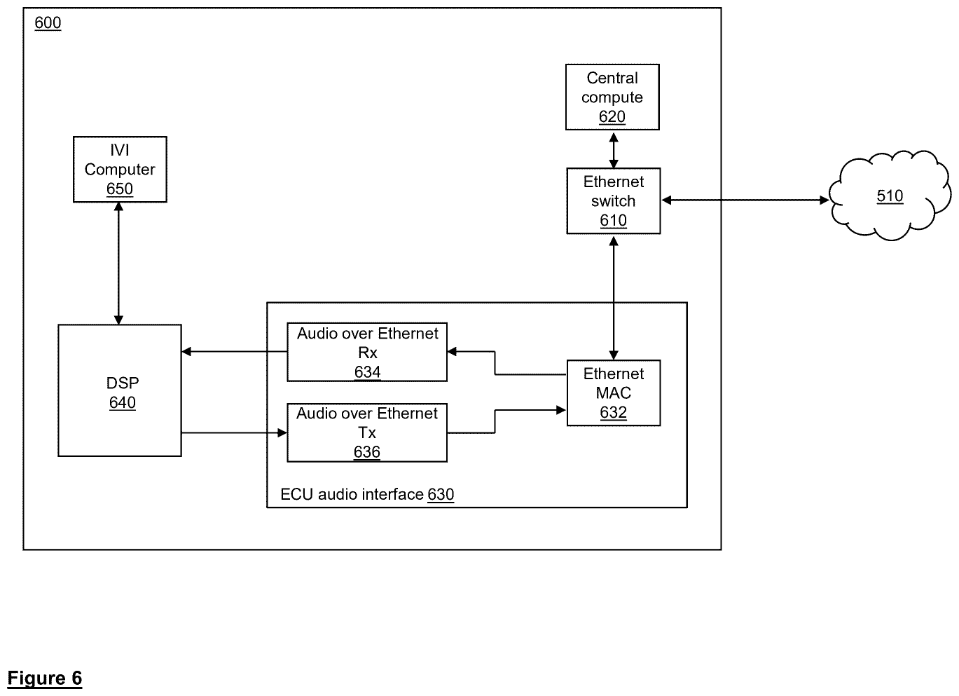

FIG. 6 is a schematic representation of the central high-performance compute ECU 600 of the communications network of FIG. 5.

The central high-performance compute ECU 600 includes an Ethernet switch 610, a central high-performance compute unit 620, an ECU audio interface 630, a DSP 640 and an IVI computer 650.

The Ethernet switch 610 is configured to be coupled to the Ethernet backbone network 510 to permit Ethernet communication between the central high-performance compute ECU 600 and the Ethernet backbone network 510.

The Ethernet switch 610 is bidirectionally coupled to the central high-performance compute unit 620 for transmitting non-audio Ethernet data to, and receiving non-audio Ethernet data from, the central high-performance compute unit 620.

The Ethernet switch 610 is also bidirectionally coupled to an Ethernet MAC 632 the ECU audio interface 630, e.g. via a media independent interface (xMII) such as a Serial Gigabit Media Independent Interface (SGMII), OA-MACPHYSPI or the like, for transmitting audio Ethernet data to, and receiving audio Ethernet data from, the ECU audio interface 630.

The ECU audio interface 630 includes an audio over Ethernet data receiver 634, having an input coupled to an output of the Ethernet MAC 632 for receiving audio data from the Ethernet MAC 632, and an output coupled to an input of the DSP 640 for outputting audio data to the DSP 640. The ECU audio interface 630 further includes an audio over Ethernet data transmitter 636, having an input coupled to an output of the DSP 640 for receiving audio data from the DSP 640, and an output coupled to an input of the Ethernet MAC 632 for transmitting audio data to the Ethernet MAC 632.

The DSP is bidirectionally coupled to the IVI computer 650, and is configured to perform signal processing operations on acoustic data received from the ECU audio interface 630, e.g. to generate RNC audio signals.

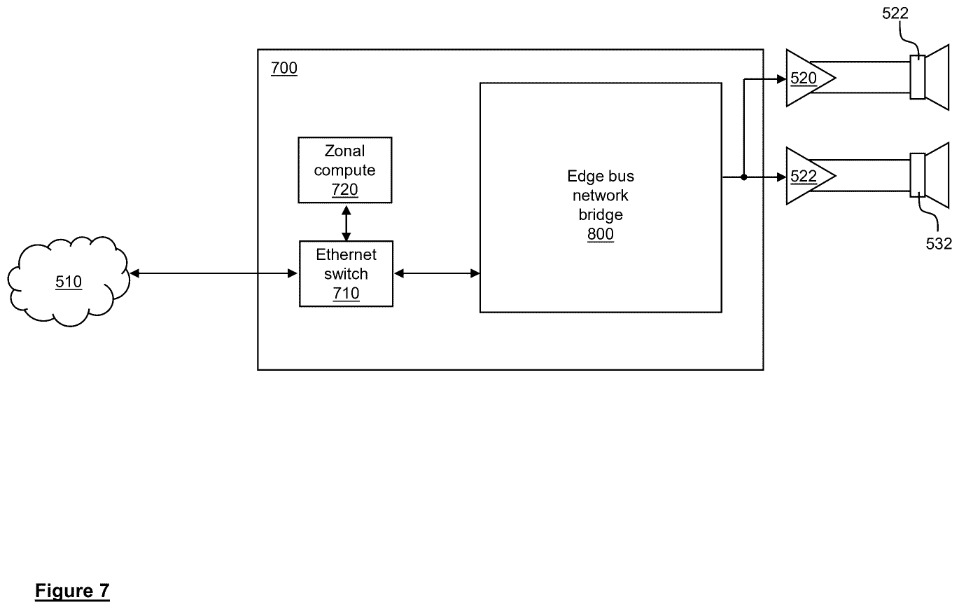

FIG. 7 is a schematic representation of the zonal ECU 700 of the communications network of FIG. 5.

The zonal ECU 700 includes an Ethernet switch 710, a zonal compute unit 720 and the network bridge 800.

The Ethernet switch 710 is configured to be coupled to the Ethernet backbone network 510 to permit Ethernet communication between the zonal ECU 700 and the Ethernet backbone network 510.

The Ethernet switch 710 is bidirectionally coupled to the zonal compute unit 720 for transmitting non-audio Ethernet data to, and receiving non-audio Ethernet data from, the zonal compute unit 720.

The Ethernet switch 710 is also bidirectionally coupled to the network bridge 800, e.g. via an xMII interface such as a Serial Gigabit Media Independent Interface (SGMII), OA-MACPHYSPI or similar, for transmitting Ethernet data to, and receiving Ethernet data from, the network bridge 800.

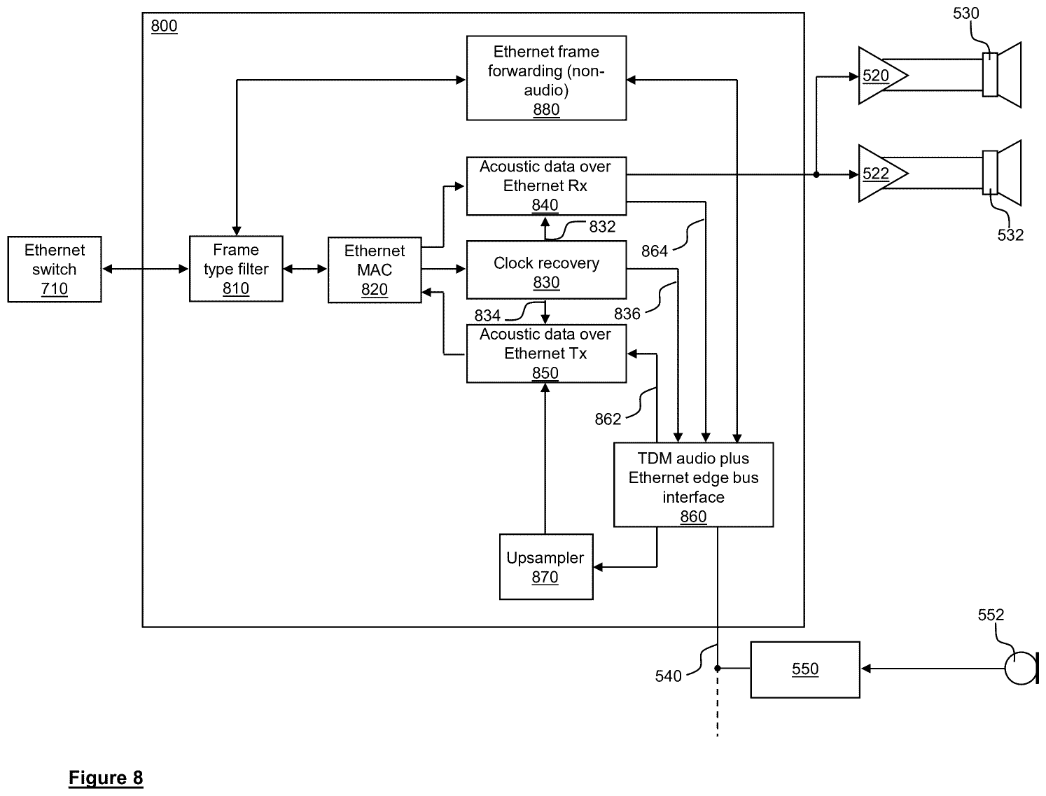

FIG. 8 is a schematic representation of the network bridge 800 of the communications network of FIG. 5. The network bridge 800 may be implemented in integrated circuitry, e.g. in a single integrated circuit (IC). The network bridge 800 may be integrated with the Ethernet switch 710 in a single IC.

The network bridge 800 may include Time Sensitive Networking (TSN) functionality to allow transducer data (e.g. audio data, accelerometer data and sensor data from the edge transducers 552, 572, 582) to be conveyed between a remote node (e.g. an edge transducer 552, 572, 582) coupled to the TDM bus 540 and a remote node on the Ethernet backbone network 510 (e.g. the central high-performance compute ECU 600) within a specified latency bound.

The network bridge 800 includes frame type filter circuitry 810, Ethernet MAC circuitry 820, clock recovery circuitry 830, acoustic data over Ethernet data receiver circuitry 840, acoustic data over Ethernet data transmitter circuitry 850, TDM audio plus Ethernet edge bus interface circuitry 860, upsampler circuitry 870, and Ethernet frame forwarding circuitry 880.

For Ethernet frames transmitted in a downstream direction from the central high-performance compute ECU 600 to the zonal ECU 700, the frame type filter circuitry 810 is configured to route incoming Ethernet frames to either the Ethernet MAC circuitry 820 or the Ethernet frame forwarding circuitry 880, depending upon the frame type. The frame type filter circuitry 810 is configured to examine header information in incoming Ethernet frames to determine the frame type. Incoming audio and synchronisation or clock frames are routed to the Ethernet MAC circuitry 820 by the frame type filter circuitry 810, while all other incoming frames are routed to the Ethernet frame forwarding circuitry 880.

In an alternative implementation, the frame type filter circuitry 810 is omitted, and the Ethernet MAC circuitry 820 and Ethernet frame forwarding circuitry 880 are coupled directly to the Ethernet switch 710, which is operative to perform the routing of incoming Ethernet frames according to their destination address or frame type, as may be indicated in header information, for example. Such an implementation may be used in applications in which the network bridge 800 is implemented as part of a larger network component (e.g. as an IP block of an integrated circuit implementing both the Ethernet switch 710 and the network bridge 800), whereas an implementation of the kind shown in FIG. 8 that includes the frame type filter circuitry 810 may be used in applications in which the network bridge 800 is implemented as a standalone component, e.g. in a dedicated network bridge IC.

The Ethernet MAC circuitry 820 is configured to receive incoming audio and synchronisation or clock frames from the frame type filter circuitry 810 (or the Ethernet switch 710, in implementations that omit the frame type filter circuitry 810) and to route synchronisation or clock frames to the clock recovery circuitry 830 and to route audio frames to the acoustic data over Ethernet data receiver circuitry 840.

The clock recovery circuitry 830 is configured to recover an audio sampling clock signal from the Ethernet backbone network 510. The clock signal may be based on a master clock source of the Ethernet backbone network 510. The clock signal may be recovered based on clock data in a received synchronisation or clock frame, or implied in the presentation timestamps of received audio frames, e.g. using Precision Time Protocol (PTP), IEEE 802.1AS or TSN functionality, as will be familiar to those of ordinary skill in the art.

The recovered clock signal is supplied by the clock recovery circuitry 830 to the acoustic data over Ethernet data receiver circuitry 840 over a first clock interface 832, to the acoustic data over Ethernet data transmitter circuitry 850 over a second clock interface 834, and to the TDM audio plus Ethernet edge bus interface circuitry 860 over a third clock interface 836. The TDM audio plus Ethernet edge bus interface circuitry 860 supplies the recovered clock signal to the TDM bus 540 for use as reference clock for the TDM bus 540.

The acoustic data over Ethernet data receiver circuitry 840 is configured to receive the recovered clock signal from the clock recovery circuitry 830 and audio Ethernet frames (i.e. Ethernet frames containing audio data) from the Ethernet MAC circuitry 820, and to output audio data contained in the received audio Ethernet frames intended for output by the first and second audio output transducers 530, 532 to the first and second audio amplifiers 520, 522, which in turn output audio signals to the first and second audio output transducers 530, 532.

The acoustic data over Ethernet data receiver circuitry 840 is further configured to output audio data intended for output by the second edge transducer 562 to the TDM audio plus Ethernet edge bus interface circuitry 860 for onward transmission to the second edge bus interface 560 over the TDM bus 540.

The acoustic data over Ethernet data receiver circuitry 840 is configured to operate with a frame interval that is not lower than a bus cycle interval of the TDM audio plus Ethernet edge bus interface circuitry 860.

Incoming Ethernet frames other than audio and synchronisation or clock frames (e.g. control frames containing control data for the fifth edge transducer 584) are routed by the frame type filter circuitry 810 (or by the Ethernet switch 710, in implementations that omit the frame type filter circuitry 810) to the Ethernet frame forwarding circuitry 880, which in turn routes the Ethernet frames to the TDM audio plus Ethernet edge bus interface circuitry 860 for onward transmission to the fourth edge bus interface 580 over the TDM bus 540.

In the upstream direction, i.e. for data transmitted from the edge transducers 552, 572, 584 over the TDM bus 540 to the zonal ECU 700 and onward to the central high-performance compute ECU 600, acoustic data originates at the first edge transducer (microphone) 552 or the third edge transducer (accelerometer) 572. As will be appreciated by those of ordinary skill in the art, accelerometer output data may not be considered to be audio data in the strict sense of the term. However, RNC systems typically use data output by one or more accelerometers to capture road vibration and data output by one or more microphones to capture acoustic road noise. The accelerometer data are typically transmitted and input to an RNC processing algorithm (e.g. performed by the DSP 640 of the central high-performance compute ECU 600) in the same way as audio data from the microphone(s). Thus, for the sake of brevity, both audio data generated by a microphone and accelerometer data generated by an accelerometer are referred to herein as audio data or acoustic data.

Data from the first edge transducer (microphone) 552 and the third edge transducer (accelerometer) 572 are transmitted over the TDM bus 540 to the TDM audio plus Ethernet edge bus interface circuitry 860 of the network bridge 800.

The TDM audio plus Ethernet edge bus interface circuitry 860 transmits the audio data to the acoustic data over Ethernet data transmitter circuitry 850, via a first low latency interface 862 (having a latency much lower than one 48 KHz sample period, i.e. much lower than 20.83 μs) such as a high speed parallel digital interface which enables very low latency transmission of the audio data to the acoustic data over Ethernet data transmitter circuitry 850 without reserialising it on an interface such as an I2S interface, which would incur a latency penalty of, e.g., one 48 KHz audio sample period or 20.83 μs.

The acoustic data over Ethernet data transmitter circuitry 850 transmits Ethernet frames containing the audio data at the same interval as a cycle interval of the TDM bus 540, e.g. every six 48 KHz audio sample periods or 125 μs.

The acoustic data over Ethernet data transmitter circuitry 850 is configured to operate with a frame interval that is not lower than a bus cycle interval of the TDM audio plus Ethernet edge bus interface circuitry 860.

The network bridge 800 may be configured such that in response to an event that is synchronous with the TDM bus cycle of the TDM bus 540, e.g. conclusion of a TDM bus cycle (the latest point in time at which transducer data may be received from the edge transducers 562, 572, 582, in a highly-loaded TDM bus configuration), transducer data is conveyed to a transmit frame buffer of the acoustic data over Ethernet data transmitter circuitry 850. As soon as the transducer data is received in the transmit frame buffer, the acoustic data over Ethernet data transmitter circuitry 850 begins transmitting an Ethernet frame containing the audio data.

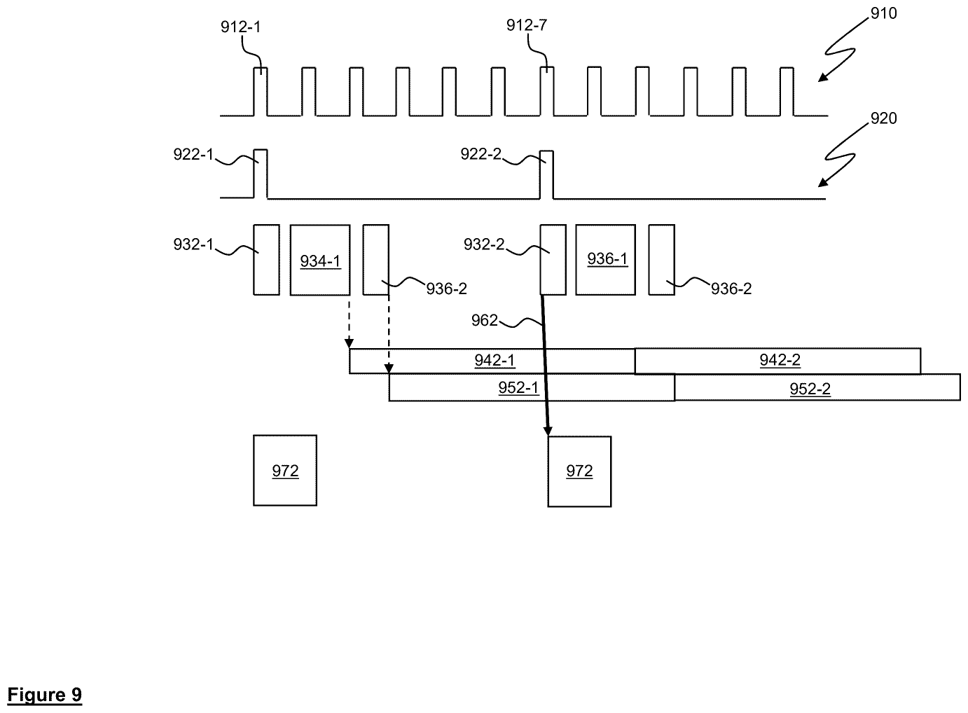

This is illustrated in the timing diagram of FIG. 9, which illustrates timing of audio sample events and transmission of audio over Ethernet frames.

The TDM bus 540 uses the clock signal recovered by the clock recovery circuitry 830 as a TDM bus reference clock.

The upper trace 910 of FIG. 9 shows a sequence of audio sample period events occurring at a sample rate of 48 KHz. The audio sample period events are synchronised to the TDM bus reference clock.

Trace 920 shows a sequence of TDM bus cycle start events which occur every 6 audio sample periods. Thus, a first TDM bus cycle event 922-1 is synchronised with a first audio sample event 912-1, and a second TDM bus cycle event 912-2 is synchronised with a seventh audio sample event 912-7. The TDM bus cycle start events are thus also synchronised to the TDM bus reference clock.

A TDM cycle beacon is transmitted on the TDM bus 540 (e.g. by the TDM audio plus Ethernet edge bus interface circuitry 860) at the start of every TDM bus cycle (and thus again in synchronisation with the clock signal recovered by the clock recovery circuitry 830). Thus, a first TDM cycle beacon 932-1 indicating the start of a first TDM cycle, is transmitted in synchronisation with the first TDM bus cycle event 922-1, and a second TDM cycle beacon 932-2 indicating the start of a second TDM cycle, is transmitted in synchronisation with the second TDM bus cycle event 922-2.

Each TDM cycle beacon 932-1, 932-2 signals, to the edge bus interfaces 550, 570, 580, the start of a TDM cycle period in which the edge bus interfaces 550, 570, 580 can transmit data from their associated edge transducers 552, 572, 582 to the TDM bus 540 in a predefined transmission order.

In the example illustrated in FIG. 9, the first edge bus interface 550 transmits a first data microframe 934-1 containing data from the first edge transducer (microphone) 552 to the TDM bus 540 immediately after the first TDM cycle beacon 932-1. Once a predefined time period for transmission of the first data microframe 934-1 has elapsed, the third edge bus interface 570 transmits a second data microframe 934-2 containing data from the third edge transducer (accelerometer) 572 to the TDM bus 540.

Similarly, the first edge bus interface 550 transmits a third data microframe 936-1 containing data from the first edge transducer (microphone) 552 to the TDM bus 540 immediately after the second TDM cycle beacon 932-2. Once a predefined time period for transmission of the third data microframe has elapsed, the third edge bus interface 570 transmits a fourth data microframe 936-2 containing data from the third edge transducer (accelerometer) 572 to the TDM bus 540.

Immediately after the predefined time period for transmission of the first data microframe 934-1 has elapsed, the first data microframe 934-1 is transmitted to a first receive buffer of the acoustic data over Ethernet data transmitter circuitry 850 over the first low latency interface 862, as indicated at 942-1 in FIG. 9. Similarly, immediately after the predefined period for transmission of the second data microframe 934-2 has elapsed, the second data microframe 934-2 is transmitted to a second receive buffer of the acoustic data over Ethernet data transmitter circuitry 850 over the first low latency interface 862, as indicated at 952-1 in FIG. 9.

In the example illustrated in FIG. 9, in response to an event that is synchronous with the TDM bus cycle of the TDM bus 540 (e.g. conclusion of a TDM bus cycle), the first and second data microframes 934-1, 934-2 are conveyed from the respective first and second receive buffers to the transmit frame buffer of the acoustic data over Ethernet data transmitter circuitry 850, as indicated by arrow 962 in FIG. 9. As soon as the first and second data microframes 934-1, 934-2 are received in the transmit frame buffer, the acoustic data over Ethernet data transmitter circuitry 850 begins transmitting an Ethernet frame 972 containing the audio data. This single Ethernet frame contains transducer data corresponding to a single period of the TDM bus 540, which corresponds to a single audio sample period.

Thus, in the example illustrated in FIG. 9, an Ethernet frame containing the data from the first and second data microframes 934-1, 934-2 is transmitted by the acoustic data over Ethernet data transmitter circuitry 850 at the earliest possible opportunity after the end of the TDM bus cycle in which the first and second data microframes 934-1, 934-2 are transmitted to the TDM bus 540, which minimises the latency of transmission of data from the edge transducers 552, 582 to the central high-performance compute ECU 600.

For example, a single Ethernet frame may contain transducer data corresponding to a single cycle of the TDM bus 540, comprising a plurality of 48 KHz audio sample periods. In an example in which a single Ethernet frame contains transducer data corresponding to six 48 KHz audio sample periods, the latency of transmission of data from the edge transducers 552, 582 to the central high-performance compute ECU 600 may be equal to six 48 KHz audio sample periods (125 μs) plus the latency for the Ethernet frame to transit the Ethernet backbone network 510, as discussed above with reference to the example latency figures presented in Table 1.

The acoustic data over Ethernet data transmitter circuitry 850 may be configured to transmit frames at a greater interval than the TDM bus cycle interval, for example in the case where the TDM bus cycle interval is short. For example, if the TDM bus cycle interval is one 48 KHz audio sample period, the frame interval of the audio-over-Ethernet transmitter may be configured to be equal to two 48 KHz sample periods (41.67 μs) or six 48 KHz sample periods (125 μs), to pack more audio data samples into each Ethernet frame and thereby increase the protocol efficiency of the audio-over-Ethernet transport.

The above discussion of bridging and latency of audio in the upstream direction from the TDM bus 540 to the Ethernet backbone network 510 applies equally to the opposite (downstream) signal path, from the Ethernet backbone network 510 to the TDM bus 540 for output audio signals destined for the audio amplifier 566.

Thus, RNC audio data samples output by the audio over Ethernet data transmitter 636 of the ECU audio interface of the central high-performance compute ECU 600 are loaded into an Ethernet frame (e.g. RNC audio data samples corresponding to a single 48 KHz audio sample interval or RNC audio data samples corresponding to up to six 48 KHz audio sample intervals) with minimal latency by the Ethernet MAC 632 of the central high-performance compute ECU 600. The resulting audio Ethernet frame is transmitted by the Ethernet switch 610 over the Ethernet backbone network 510 to the zonal ECU 700.

The acoustic data over Ethernet data receiver circuitry 840 of the network bridge 800 includes a receive buffer for receiving the audio data samples destined for the second edge transducer 562 (speaker) from the received Ethernet frame. The acoustic data over Ethernet data receiver circuitry 840 transfers the received audio data samples from the receive buffer to a transmit buffer of the acoustic data over Ethernet data receiver circuitry 840 in response to an event that is synchronous with the TDM bus cycle of the TDM bus 540, e.g. conclusion of a TDM bus cycle. As soon as the audio data samples are received in its transmit buffer, the acoustic data over Ethernet data receiver circuitry 840 begins transmitting the audio data samples to the TDM audio plus Ethernet edge bus interface circuitry 860, via a second low latency interface 864 (having a latency much lower than one 48 KHz sample period, i.e. much lower than 20.83 μs) such as a high speed parallel digital interface. The TDM audio plus Ethernet edge bus interface circuitry 860 transmits the audio samples to the second edge bus interface 560 over the TDM bus 540.

The TDM bus 540 may be configured to carry Ethernet frames, e.g. Ethernet frames containing control data for the fifth edge transducer (transducer or transducer controller), in addition to transducer data. Such Ethernet frames are received by the network bridge 800, and are routed by the frame type filter circuitry 810 (or Ethernet switch 710, if the frame type filter circuitry 810 is not present) to the Ethernet frame forwarding circuitry 880, which in turn routes the received Ethernet frames to the TDM audio plus Ethernet edge bus interface circuitry 860 for onward transmission over the TDM bus 540. Such Ethernet frames can be transmitted with transducer data over the TDM bus 540. For example, both Ethernet frames and transducer data can be transmitted over the TDM bus 540 in a single TDM cycle period.

As noted above, the network bridge 800 in the FIG. 8 example includes upsampler circuitry 870, which permits the use of a lower sampling rate for accelerometer data than for other data generated by the edge transducers, e.g. a microphone.

In some examples, the TDM bus 540 may have limited bandwidth due to its low bit rate. Accelerometers used for RNC systems typically have a bandwidth in the range 500 Hz-2 kHz. Accordingly, it may be advantageous to sample the third edge transducer (accelerometer) 572 at a lower sample rate than the 48 kHz sample rate of audio streams, such as a sample rate that is the same as the bus cycle rate of the TDM bus 540.

In the example described above, that TDM cycle rate is 8 kHz (as the sample rate is 48 KHz and each TDM bus cycle has a duration of 6 sample periods), and the gross data bandwidth of the bus is 10 Mbit/s.

Accelerometers used in RNC systems typically produce three-channel data, (one channel for each orthogonal physical axis), typically with an output interface resolution of 16 bits. If sampled at the same rate as audio (48 kHz), the data bit rate of the sampled accelerometer signal is 2.304 Mbit/s, or 23% of the total gross bit rate of the TDM bus 540. In contrast, if the accelerometer is sampled at the minimum rate consistent with the cycle rate of the TDM bus 540, e.g. 8 kHz in the example described above, the bit rate instead is 0.384 Mbit/s, or 3.8% of the total gross bit rate of the TDM bus 540, with no significant reduction in accelerometer signal quality because the bandwidth of the actual accelerometer signal is far below the Nyquist limit for sampling at 8 KHz. This reduction in bus usage of nearly 20% enables substantially more audio channels or Ethernet control data to be conveyed instead.

RNC systems are typically designed for all input signals and all output signals to be at 48 KHz. This is because their microphone input signals are usually used for voice communication as well as RNC, requiring a sample rate higher than 8 kHz, and usually 48 KHz. The loudspeaker amplifiers used for RNC are typically also used for audio applications such as voice communication, music/radio playback and driver alert tones at a sample rate of 48 KHz, so RNC outputs are typically at 48 kHz and mixed digitally with these other signal sources before transmission to the amplifiers. With all these other input/output signals being 48 KHz sample rate, RNC accelerometers are conventionally handled in the same way as these audio channels for consistency and ease of interfacing, i.e. each accelerometer is treated as a 3-channel 48 kHz audio source, despite the signal bandwidth of the accelerometer being very low relative to the Nyquist bandwidth of a 48 KHz sampled signal.

The upsampler circuitry 870 of the network bridge 800 enables a lower sample rate to be used for sampling accelerometers (e.g. the third edge transducer 572) in the communications network 500 of the present disclosure. As described above, the use of a lower sample rate for accelerometer data helps to optimise usage of the limited data bandwidth of the TDM bus 540.

The upsampler circuitry 870 is configured to convert sampled data on the TDM bus 540 at a first, lower, sample rate such as 8 kHz to a second, higher, data rate, e.g. 48 KHz, for transport over the Ethernet backbone network 510 together with other data at the second data rate (e.g. 48 KHz audio data) to the DSP 640 of the central high-performance compute ECU 600 which may be configured to receive 48 KHz input signals.

The communications network 500 of the present disclosure enables low-latency upstream transmission of transducer data from an edge network to the zonal ECU 700 and on to the central high-performance compute ECU 600 over the Ethernet backbone network 510, and low-latency downstream transmission of RNC audio data from the central high-performance compute ECU 600 over the Ethernet backbone network 510 to the zonal ECU 700 and on to the audio amplifiers 520, 522 and/or to an audio amplifier and associated output transducer (e.g. a speaker) of the edge network. The latency of the upstream and downstream transmission is sufficiently low as to enable effective road noise cancellation without the need for cabling for a dedicated RNC audio network in addition to the backbone Ethernet network, thus reducing the cost and weight of an RNC system implemented using the communications network 500, as compared to known solutions that use parallel Ethernet and RNC audio networks.

The communications network 500 and the network bridge 800 described above with reference to the accompanying drawings may be incorporated in a host device such as a vehicle (e.g. a car, a commercial vehicle such as a truck, lorry or bus, an aircraft or the like) or a room-based noise cancellation device.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re) programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general purpose processor or the like. A module may itself comprise other modules or functional units. A module may be provided by multiple components or sub-modules which need not be co-located and could be provided on different integrated circuits and/or running on different processors.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. A communications network for a vehicle comprising:
a central processing node;
a zonal node;
an Ethernet network coupling the central processing node to the zonal node; and
an edge network coupled to the zonal node, the edge network comprising a time domain multiplexing (TDM) bus and a plurality of edge transducers coupled to the TDM bus,
wherein the zonal node comprises a network bridge for bridging transducer data received from the TDM bus to the Ethernet backbone network,
wherein the network bridge comprises:
interface circuitry for interfacing the network bridge with the TDM bus;
clock recovery circuitry for recovering a clock signal for use by the edge network from an Ethernet frame received from the Ethernet network, wherein a TDM cycle of the TDM bus is synchronised to the recovered clock signal;
acoustic data receiver circuitry coupled to the interface circuitry by a first low-latency data path, wherein the acoustic data receiver circuitry is configured to transmit acoustic data contained in Ethernet frames received at the network bridge from the Ethernet network to the interface circuitry; and
acoustic data transmitter circuitry coupled to the interface circuitry by a second low-latency data path, wherein the acoustic data transmitter circuitry is configured to transmit Ethernet frames containing acoustic data received at the interface circuitry from the edge network to the Ethernet network.

2. The communications network of claim 1, wherein the acoustic data transmitter circuitry comprises receive buffers for receiving transducer data from each of the plurality of edge transducers.

3. The communications network of claim 2, wherein the acoustic data transmitter circuitry is configured to transfer transducer data from the receive buffers to a transmit buffer of the acoustic data transmitter circuitry in response to an event that is synchronous with a TDM bus cycle of the TDM bus.

4. The communications network of claim 3, wherein the acoustic data transmitter circuitry is configured to begin transmitting an Ethernet frame containing the transducer data as soon as the transducer data has been transferred to the transmit buffer.

5. The communications network of claim 1, wherein the acoustic data receiver circuitry comprises a receive buffer for receiving the acoustic data from the Ethernet frames received at the network bridge from the Ethernet network.

6. The communications network of claim 5, wherein the acoustic data transmitter circuitry is configured to transfer acoustic data from the receive buffer to a transmit buffer of the acoustic data transmitter circuitry in response to an event that is synchronous with a TDM bus cycle of the TDM bus.

7. The communications network of claim 6, wherein the acoustic data receiver circuitry is configured to begin transmitting the acoustic data as soon as the acoustic data has been transferred to the transmit buffer.

8. The communications network of claim 1, wherein the audio data receiver circuitry and the data transmitter circuitry are configured to operate with a frame interval not lower than a bus cycle interval of the TDM bus.

9. The communications network of claim 1, wherein the TDM bus is configured to carry Ethernet frames and acoustic data.

10. The communications network of claim 1, wherein the TDM bus comprises a twisted pair cable.

11. The communications network of claim 1, wherein the edge transducers are coupled to the TDM bus in a multi-drop or daisy-chain network configuration.

12. The communications network of claim 1, wherein the plurality of edge transducers comprises a microphone and an accelerometer.

13. The communications network of claim 12, wherein the plurality of edge transducers further comprises at least one of:
an audio output transducer;
a sensor;
a light-emitting diode (LED); and
a motor controller.

14. The communications network of claim 1, wherein the edge network is configured to convey transducer data and Ethernet frames.

15. The communications network of claim 12, wherein the network bridge comprises upsampler circuitry for upsampling accelerometer data received at the network bridge over the TDM bus to a rate equal to a sampling rate of microphone audio data samples received over the TDM bus.

16. The communications network of claim 1, wherein the central processing node comprises:
an acoustic data interface; and
a digital signal processor (DSP),
wherein the acoustic data interface is configured to:
receive Ethernet frames containing acoustic data from the Ethernet switch and transmit the acoustic data to the DSP;
receive a road noise cancellation (RNC) signal from the DSP and transmit the RNC signal to the Ethernet switch for transmission to the zonal node over the Ethernet network,
and wherein the DSP is configured to generate the RNC signal based on the acoustic data.

17. A network bridge for bridging a time domain multiplexing (TDM) data network operating at a first data rate to an Ethernet network operating at a second data rate that is higher than the first data rate, the network bridge comprising:
interface circuitry for interfacing the network bridge with the TDM data network;
clock recovery circuitry for recovering a clock signal for use by the TDM data network from a from a frame received from the Ethernet network;
acoustic data receiver circuitry coupled to the interface circuitry by a first low-latency data path, wherein the acoustic data receiver circuitry is configured to transmit acoustic data contained in Ethernet frames received at the network bridge from the Ethernet network to the interface circuitry; and
acoustic data transmitter circuitry coupled to the interface circuitry by a second low-latency data path, wherein the acoustic data transmitter circuitry is configured to transmit Ethernet frames containing acoustic data received at the interface circuitry from the TDM data network to the Ethernet network.

18. The network bridge of claim 17, further comprising upsampler circuitry configured to upsample transducer data received from the TDM data network.

19. An integrated circuit comprising the network bridge of claim 17.

20. A road noise cancellation (RNC) system for a vehicle, the RNC system comprising:
a central compute ECU;
a zonal ECU coupled to the central compute ECU by an Ethernet network; and
an edge network, the edge network comprising an accelerometer and a microphone coupled to a time domain multiplexing (TDM) bus,
wherein the zonal ECU comprises a network bridge configured to bridge acoustic data received from the edge network to the Ethernet network,
and wherein the central compute ECU is configured to:
receive the acoustic data from the Ethernet network;
generate a road noise cancellation signal based on the received acoustic data; and
transmit the road noise cancellation signal to an audio output transducer over the Ethernet network.

21. A communications network for a vehicle comprising:
a central processing node;
a zonal node;
an Ethernet network coupling the central processing node to the zonal node; and
an edge network coupled to the zonal node, the edge network comprising a time domain multiplexing (TDM) bus and a plurality of edge transducers coupled to the TDM bus,
wherein the zonal node comprises a network bridge for bridging acoustic data received from the TDM bus to the Ethernet backbone network.

22. A host device comprising the communications network of claim 21, wherein the host device comprises a car, a commercial vehicle, a truck, a lorry, a bus, an aircraft or a room-based noise cancellation device.
